(19) United States
(12) Patent Application Publication
(10) Pub. No.: US 2010/0281261 A1
(43) Pub. Date: Nov. 4, 2010

(54) DEVICE AND METHOD FOR NEAR FIELD COMMUNICATIONS USING AUDIO TRANSDUCERS

(75) Inventor: Charles Razzell, Pleasanton, CA (US)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/743,425

(22) PCT Filed: Nov. 13, 2008
(86) PCT No.: PCT/IB2008/054765

§ 371 Date: May 18, 2010

(30) Foreign Application Priority Data
Nov. 21, 2007 (US) 60989547

(51) Int. Cl. H04L 29/06; H04B 5/00; H04L 9/00; H04K 1/00

(52) U.S. Cl. 713/171; 455/41.1; 713/168; 380/270

(57) ABSTRACT

Secure wireless communication links are established between proximately-located devices, each of which includes respective audio transmitters and audio receivers. The audio transmitter of the first device can be used to transmit a device-dependent authentication key, which is received by the audio receiver of the second device. The audio transmitter of the second device can be used to transmit an acknowledgement, which is received at the audio receiver of the first device. The round-trip time from transmitting the authentication key from the first device to receiving the acknowledgement at the first device can be determined, and the decision of whether to establish the secure wireless communication link can be based on the determined round-trip time. In certain embodiments, these steps can be repeated starting with the second device to establish a two-way trust between the devices.

### FIELD OF THE INVENTION

The present invention relates generally to wirelessly exchanging data between devices over short distances, and particularly to using acoustic signals to exchange data between devices over short distances, for example to establish a secure communications link.

### BACKGROUND

Near Field Communication (NFC) is a short-range wireless communication technology that provides for the exchange of data between devices distances typically up to about 20 cm. NFC technology is based on RFID, and works by magnetic field induction using relatively low data rates (specified speeds are 106 kbit/s, 212 kbit/s and 424 kbit/s). NFC technology is primarily used with mobile phones, and can be used to provide services such as: card emulation, in which the NFC-enabled device behaves like an existing contactless card; RFID reader, in which the NFC-enabled device is active and reads a passive RFID tag, for example for interactive advertising; and communications mode, in which two NFC-enabled devices exchange information.

NFC and Bluetooth are both short-range communication technologies which have recently been integrated into mobile phones. The significant advantage of NFC over Bluetooth is the shorter set-up time. Instead of performing manual configurations to identify Bluetooth devices, the connection between two NFC-enabled devices is established immediately (<0.1 s). To avoid the complicated configuration process, NFC can be used to set up the Bluetooth link.

### SUMMARY

Various aspects of the present invention are directed to methods for establishing a secure wireless communication link between first and second proximately-located devices, each of which includes respective audio transmitters and audio receivers. The methods can include using the audio transmitter of the first device to transmit a device-dependent authentication key, receiving the transmitted authentication key at the audio receiver of the second device and using the audio transmitter of the second device to transmit an acknowledgement, receiving the acknowledgement at the audio receiver of the first device, determining the round-trip time from transmitting the authentication key from the first device to receiving the acknowledgement at the first device, and determining whether to establish the secure wireless communication link based on the determined round-trip time. In certain embodiments, these steps can be repeated starting with the second device to establish a two-way trust between the devices.

Consistent with example embodiments, the present invention is directed mobile communications devices that include an audio transmitter, an audio receiver, and circuitry adapted to send audio data packets via the audio transmitter, receive audio data packets via the audio receiver, calculate round-trip times between sending audio data packets and receiving audio acknowledgements, and validate audio communications based on the calculated round-trip times.

Consistent with example embodiment, the present invention is further directed to methods for use with a mobile communications device having an audio transmitter, an audio receiver, and a processor adapted to send audio data packets via the audio transmitter and receive audio data packets via the audio receiver. The methods can include adapting the mobile communications device to establish secure communication links by uploading a program to the mobile communications device, the program being executable by the processor to calculate round-trip times between sending audio data packets and receiving audio acknowledgements, and to validate audio communications based on the calculated round-trip times.

The above summary is not intended to describe each embodiment or every implementation of the present disclosure. The figures and detailed description that follow more particularly exemplify various embodiments.

### BRIEF DESCRIPTION OF THE DRAWINGS

The invention may be more completely understood in consideration of the following detailed description of various embodiments of the invention in connection with the accompanying drawings, in which:

FIG. 1 illustrates establishing a communications link between proximately-located devices via acoustic signals in accordance with embodiments of the present invention;

FIG. 2 illustrates circuitry for use in a device for establishing communications links with proximately-located devices via acoustic signals in accordance with embodiments of the present invention; and

FIG. 3 illustrates steps that can be performed in accordance with embodiments of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention including aspects defined by the appended claims.

### DETAILED DESCRIPTION

Embodiments of the present invention relate to using acoustic signals, for example airborne acoustic signals, to exchange data between proximately-located devices. The acoustic signals can be transmitted and received using audio transducers, for example a speaker and microphone of a mobile phone. As such, embodiments of the present invention can advantageously utilize existing audio transducers as the means of out-of-band communications. For example, the audio transducers already existing in mobile phone devices, along with voiceband modem technology, can be used to establish communications links with other proximately-located devices without the need for adding the hardware required with typical NFC techniques. At the same time, all the services normally provided by NFC can still be provided.

As discussed, NFC operates over short distances and enables electronic devices such as cell phones and PDAs to connect with each other and share information simply by being positioned close together. While NFC has been purported to have a great number of potential applications, the cost, size and integration difficulties may limit widespread adoption in mass-market mobile phones. NFC transducers are not small and are difficult to integrate into typical cell-phone case mechanics, especially when using metalized parts, which can detune or block the NFC transducers. Acoustic data exchange to establish secure links between proximately-located devices can overcome the difficulties of common NFC techniques by providing an easily integrated solution that is not prone to interference and that can provide the same functionality.

In various embodiments of the present invention, the round-trip flight time between sending acoustic data and receiving acoustic acknowledgements can be measured in an effort to provide communications security. For example, a deliberate upper bound on the operating distance can be implemented by rejecting all communications for which the round-trip time is greater than a specified maximum. This can help reduce the possibility of eavesdropping. In addition, robust communication can be obtained in the presence of ambient acoustic noise by using appropriate filtering, extra error correction coding, and lower data rate. The various embodiments of the present disclosure are independent of modem speed and modulation technique.

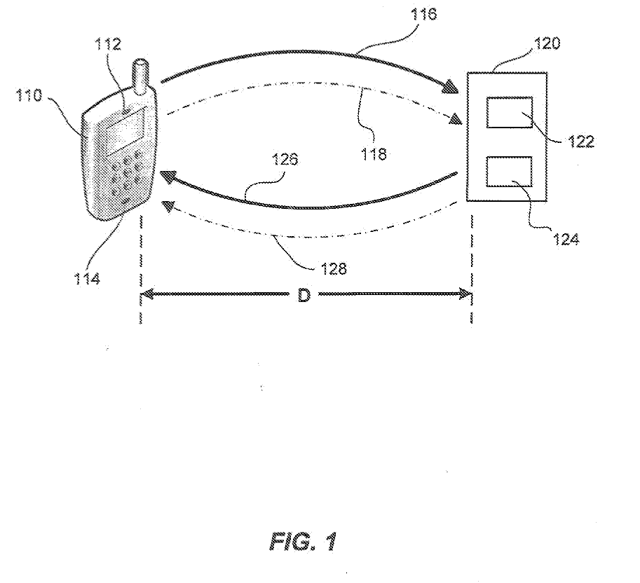

FIG. 1 illustrates an example of a communications link between a first device 110 and a second device. As shown, first device 110 is a mobile device such as a cell phone, PDA, media player, or the like, although it will be appreciated that any suitable device can be used. Second device 120 can be a stationary device such as a ticketing or electronic banking kiosk, fixed points in a building such as limited access doors or security checkpoints, and the like, or can be another mobile device. Device 110 is equipped with an audio transmitter 112, such as a speaker, and an audio receiver 114, such as a microphone. While audio transmitter 112 and audio receiver 114 are shown separately, they can be provided in any suitable manner. Preferably, the audio transducers already used in the device are used as the audio transmitter and receiver. Device 120 is likewise equipped with an audio transmitter 122 and an audio receiver 124.

In an example embodiment, when device 110 is brought into proximity with device 120, the audio transmitter 112 can be used to send an audio data message 116. The message 116 can include an identifier, or device-dependent authentication key. The identifier can be randomly generated to promote additional security. The message 116 can also include a timestamp indicating the time at which the message 116 was sent. Message 116 can be received at the audio receiver 124 of device 120. Once received, the message 116 can be subject to an immediate acknowledgement message 126 sent by the audio transmitter 122 of device 120. Acknowledgement 126 can include the identifier from message 116, along with a timestamp indicating when message 116 was received and/or when acknowledgement 126 was sent. Upon receiving acknowledgement 126 at audio receiver 114, device 110 can compute the round-trip time from sending audio message 116 to receiving audio acknowledgement 126. Using the determined round-trip time, and knowing the speed of sound in the propagation medium (e.g., air), the distance D between the devices can be determined. A maximum round-trip time can be set to place a limit on D. This provides a certain measure of security. As a further security measure, the timestamps can be used to determine whether the first leg of the round-trip communication (time from sending message 116 from device 110 to receiving message 116 at device 120) matches the second leg of the round-trip communication (time from sending acknowledgement 126 from device 120 to receiving acknowledgement 126 at device 110).

Once the devices 110 and 120 are securely paired, desired communications can take place. For example, pairing of devices 110 and 120 by acoustic communications can be used as an out-of-band method of exchanging encryption keys that are used for secure in-band communications. The pairing can also be used to quickly link the devices for Bluetooth communications. As will be appreciated, any suitable procedures for device pairing can be used, for example Diffie-Hellman key agreement methods.

Referring back to FIG. 1, if two-way mutual trust is desired, device authentication can optionally take place from device 120 to device 110 in a similar ping-and-echo fashion as from device 110 to device 120. For example, message 128 can be sent acoustically from the audio transmitter 122 of device 120, where message 128 includes an identifier (for example a randomly generated authentication key specific to device 120) and optionally a timestamp. When message 128 is received by audio receiver 114 of device 110, an acknowledge message 118 can be sent back from the audio transmitter 112 of device 110. The acknowledge 118 can include the identifier sent in message 128, along with a timestamp indicating when acknowledge 118 was sent and/or when message 128 was received. Device 120 receives the acknowledge message 118 at audio receiver 124. Round-trip time for the communication can be determined and used as described above to establish a mutual trust pairing.

A datagram, for example containing a unique, random identifier, can be sent from device A, and subject to an immediate acknowledgement upon its receipt at device B. In its acknowledgement, device B can echo the identifier supplied by device A, and can also supplies a unique identifier specific to device B. The round-trip delay from device A to device B and back to device A can establish a proximity trust relationship, and can prevent a distant intercept device from acting as man-in-the-middle. If mutual trust, rather than one-way trust, is desired the ping-and-echo response can be repeated starting with device B initiating the ping.

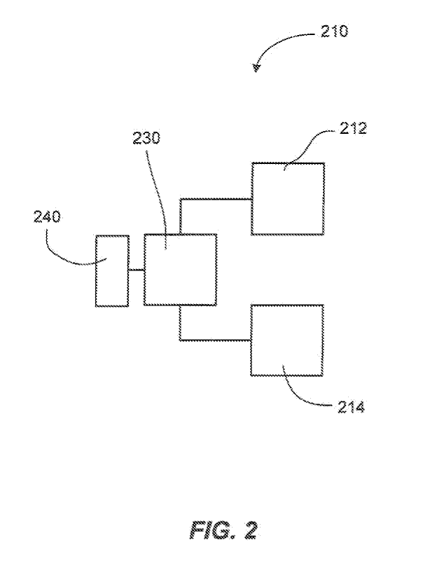

FIG. 2 schematically illustrates a circuit 210 for sending a receiving audio data messages using audio transmitter 212 and audio receiver 214, and for determining round-trip times of acoustic communications. A processor unit 230 can be connected to the transmitter 212 and receiver 214 to send and receive audio communications in a suitable manner. In the case of a mobile phone equipped with speaker phone capabilities, the processor unit 230 can be used to send and receive acoustic messages in a manner similar to transmitting and receiving voice signals during a phone call. Processor 230 can be adapted to determine round-trip times so that a secure communications link can be established as described above. Processor 230 can include or be connected to an internal memory 240, for example a non-volatile memory, that stores a program for generating and decoding audio messages and for determining round-trip times so that secure communications links between proximately-located devices can be established. As such, existing devices can be enabled to perform methods of the present disclosure by storing such a program, for example as firmware, in a non-volatile memory on the device so that it can be accessed by the processing unit.

As discussed, in certain embodiments secure communications can be established by limiting the distance over which replies are considered valid. Considering that the speed of sound in air is 344 m/s, each millisecond of round-trip time for a message can be considered as representing 17 cm of distance between the two devices. If device separations are limited to 0.5 m, the maximum round-trip can therefore be set at 6 ms. To help ensure reliability, turnaround times for the immediate acknowledge should be specified as low enough so that no allowance for turn-around time need be made in computing the round-trip time, and thus the distance between devices. For example, allowing turn-around times of 3 ms creates a device-to-device uncertainty of 0.5 m, allowing a rogue device capable of an instant turn-around to eavesdrop on communications and be up to 0.5 m farther away.

In addition to the round-trip time limitations, acoustic power levels can be kept to a minimum to reduce the probability of discrete interception. Note that a potential eavesdropping device located a large distance away must transmit loudly enough to be heard by the devices at that distance, and as such risks being detected by human ears that are in the vicinity. Embodiments of the present invention contemplate using any desired acoustic frequency, including audible frequencies as well as ultrasonic sound. However, if ultrasonic frequencies are used, ultrasonic transducers would likely be required rather than being able to utilize the existing audio transducers found in mobile phones. Using ultrasonic frequencies can reduce the likelihood of unauthorized human intercept.

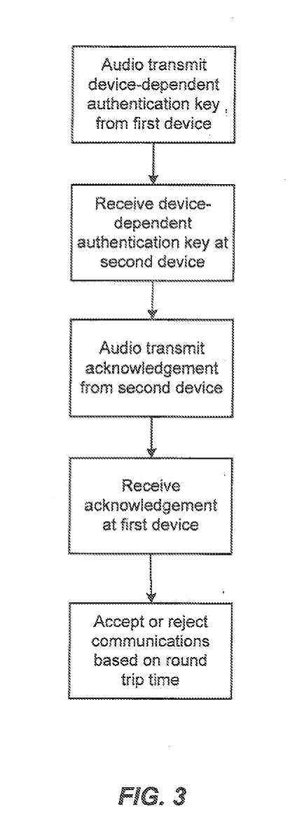

By way of summary, FIG. 3 illustrates steps that can be performed in embodiments of the present invention. These steps include acoustically transmitting a device-dependent authentication key from a first device. The acoustic message bearing the device-depending authentication key can then be received at a second device. The second device generates an acknowledgement message, which is transmitted acoustically and received back at the first device. A communications link can be established or rejected based on the time for round-trip acoustic communication, and therefore proximity of the devices.

Applications of embodiments of the present invention include: mobile ticketing in public transportation (e.g., ticket validation and fare collection terminals); mobile payment (the mobile phone acts as a debit/credit payment card); Bluetooth pairing; electronic ticketing; electronic money; travel cards; identity documents; mobile commerce; electronic keys (home, office, hotel). Embodiments of the present invention can be particularly suited for application with portable devices that may benefit from a low-cost means of out-of-band communication, for example to set up cryptographic keys, to enable secure transactions at point-of-sale, ticket validation, and the like.

The various embodiments described above and shown in the figures are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. For instance, one or more of the above example embodiments may be implemented with a variety of approaches, including digital and/or analog circuitry and/or software-based approaches. The above example embodiments and implementations may also be integrated with a variety of circuits, devices, systems and approaches. Such modifications and changes do not depart from the true scope of the present invention that is set forth in the following claims.

What is claimed is:

1. A method for establishing a secure wireless communication link between first and second proximately-located devices, each of which includes respective audio transmitters and audio receivers, the method comprising:
using the audio transmitter of the first device to transmit a device-dependent authentication key;
receiving the transmitted authentication key at the audio receiver of the second device, and using the audio transmitter of the second device to transmit an acknowledgement;
receiving the acknowledgement at the audio receiver of the first device;
determining the round-trip time from transmitting the authentication key from the first device to receiving the acknowledgement at the first device; and
determining whether to establish the secure wireless communication link based on the determined round-trip time.

2. The method of claim 1, further comprising limiting the proximity of communications by rejecting any acknowledgement received at the first device after a threshold response time has elapsed from the time of transmitting the authentication key.

3. The method of claim 2, wherein the threshold response time corresponds to a distance between devices of 1 m or less.

4. The method of claim 1, wherein the second device transmits a further device-dependent authentication key that is received by the first device along with the acknowledgement.

5. The method of claim 4, further comprising transmitting a further acknowledgement from the first device in response to the further device-dependent authentication key, and receiving the further acknowledgement at the second device.

6. The method of claim 5, further comprising determining a further round-trip time from transmitting the further authentication key from the second device to receiving the further acknowledgement at the second device.

7. The method of claim 6, wherein the communication link is established only if the round-trip time determined at the first device sufficiently matches the further round-trip time determined at the second device.

8. The method of claim 1, wherein acoustic communications take place using an audible frequency range.

9. The method of claim 1, wherein acoustic communications take place using a frequency just outside of the audible range.

10. The method of claim 1, wherein acoustic communications take place using an ultrasonic frequency range.

11. The method of claim 1, wherein the secure communications link is used to exchange an encryption key used for further communications between the first and second devices.

12. A mobile communications device comprising:
an audio transmitter;
an audio receiver;
circuitry adapted to send audio data packets via the audio transmitter, receive audio data packets via the audio receiver, calculate round-trip times between sending audio data packets and receiving audio acknowledgements, and validate audio communications based on the calculated round-trip times.

13. The device of claim 12, wherein the audio transmitter is a speaker.

14. The device of claim 12, wherein the audio transmitter is a microphone.

15. The device of claim 12, wherein the device is a cell phone.

16. A method for use with a mobile communications device having an audio transmitter, an audio receiver, and a processor adapted to send audio data packets via the audio transmitter and receive audio data packets via the audio receiver, the method comprising adapting the mobile communications device to establish secure communication links by:
storing a program in a memory location of the mobile communications device, the program being executable by the processor to calculate round-trip times between sending audio data packets and receiving audio acknowledgements, and to validate audio communications based on the calculated round-trip times.
